(19) United States
(12) Patent Application Publication
(10) Pub. No.: US 2005/0014869 A1
(43) Pub. Date: Jan. 20, 2005

(54) Curable compositions of N-alkyl melamine formaldehyde and carbamate resins

(76) Inventors: John C. Brogan, Greenwich, CT (US); Urvee Y. Treasurer, Stamford, CT (US); Lawrence A. Flood, Norwalk, CT (US)

Correspondence Address: James A. Jubinsky;Cytec Industries Inc., 1937 W. Main St., P.O. Box 60, Stamford, CT, 06904-0060, US

(21) Appl. No.: 10/871,807

(22) Filed: Jun. 18, 2004

Related U.S. Application Data
(60) Provisional application No. 60/488,625, filed on Jul. 18, 2003.

(51) Int. Cl. C08K 5/34; C08K 5/48

(52) U.S. Cl. 524/90; 525/452

(57) ABSTRACT

This invention relates to curable composition comprising a carbamate resin and a crosslinking compound having the structure of Formula I: 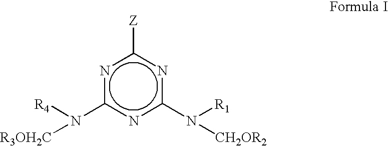
wherein Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms. Another embodiment of this invention is waterborne curable composition comprising the crosslinking compound of Formula I, a carbamate resin and water.

This application claims the benefit under 35 U.S.C. § 119(e) of U.S. Provisional Application Ser. No. 60/488,625 filed Jul. 18, 2003.

### FIELD OF THE INVENTION

The invention is directed to curable compositions. In particular, the invention relates to curable compositions comprising N-alkyl melamine and/or guanamine-based crosslinking compounds with carbamate resins.

### BACKGROUND OF THE INVENTION

Traditional industrial coatings have for years been based in significant part on backbone resins having active hydrogen groups crosslinked with various derivatives of amino-1,3,5-triazines. Most notable among the amino-1,3,5-triazine derivatives are the aminoplasts such as the alkoxymethyl derivatives of melamine and guanamines which, while providing excellent results in a number of aspects, have the disadvantage of not providing high quality, high gloss films at low temperature cures. High temperature crosslinking systems require more energy to cure and/or crosslink slower resulting in less throughput. In addition, further effort has been expended to develop crosslinkers with lower viscosity at a given solids content to reduce volatile organic compound (VOC) emissions. As a result, it has long been a desire of industry to find acceptable alternative crosslinkers and coatings systems, which cure at lower temperatures, yield lower VOCs and provide high quality, high gloss films.

South African Patent Application 721933 discloses the use of N-alkyl melamine formaldehyde crosslinking agent with a water dispersible hydroxy-functional acrylic polymer for electrodepositing a film on metal. However, the document neither discloses nor teaches using the N-alkyl amino crosslinking agent with a carbamate resin.

An article by Bright et al., entitled “Alkylmelamine Crosslinking Agent in High Solids Coating Systems” in Polymeric Material Science Engineering, (55 PMSEDG 1986, pgs. 229 to 234) discloses the use of N-alkyl melamine formaldehyde crosslinking agent with hydroxy-functional acrylic and polyester polymers. The article notes that films containing the N-alkyl melamine formaldehyde crosslinking agent have poor humidity resistance. The document neither discloses nor teaches using the N-alkyl amino crosslinking agent with a carbamate resin.

### SUMMARY OF THE INVENTION

This invention relates to curable composition comprising a carbamate resin and a crosslinking compound having the structure of Formula I: 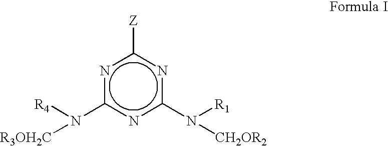
wherein Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms. Another embodiment of this invention is a waterborne curable composition comprising the crosslinking compound of Formula I, a carbamate resin and water.

### DETAILED DESCRIPTION OF THE INVENTION

In the present invention, the term “urethane resin” means a resin that contains a urethane linkage —NH—CO—O— in the backbone of the resin.

The term “pendant carbamate resin” means a resin that contains a pendant carbamate functionality and/or is end-capped with a carbamate functionality. A non-limiting example of a carbamate functionality is the group —O—CO—NHR₇ wherein R₇ is hydrogen or a C₁ to C₈ alkyl.

The term “carbamate resin” means either a urethane resin and/or a pendant carbamate resin.

The term “and/or” means either or both. For example, “A and/or B” means A or B, or both A and B.

In this invention the term “resin” and “polymer” are used interchangeably.

This invention relates to curable composition comprising a carbamate resin and a crosslinking compound having the structure of Formula I: 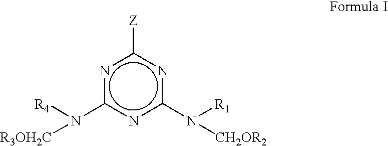
wherein Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms.

Another embodiment of this invention is waterborne curable composition comprising the crosslinking compound of Formula I, a carbamate resin and water.

In the above compound of Formula I, Z is preferably —NR₅CH₂OR₆. In addition, R₁ to R₆ are preferably each independently a C₁ to C₈ alkyl or each independently a C₁ to C₄ alkyl. R₁, R₄ and R₅ are more preferably methyl.

The above crosslinking compound of Formula I may be prepared by the procedure outlined in the aforementioned paper by Bright et al., herein incorporated by reference. The crosslinker may be prepared by first preparing a mono-, bis- or tris-alkylmelamine. These alkylmelamines may be produced by reacting cyanuric chloride with a monoalkylamine in a suitable solvent at temperatures ranging from −5° C. to 50° C. for 0.5 to 15 hours. The resulting intermediate may be reacted with additional monoalkylamine and/or ammonia at temperatures ranging from 50° C. to 120° C. for 0.5 to 24 hours to produce the mono-, bis- or tris-alkylmelamines. The alkylmelamines may then be reacted with excess formaldehyde (methylolation step) under acid or basic conditions at temperatures ranging from 20° C. to 70° C. for 0.1 to 5 hours. The methylolated product is then etherified with an alcohol under acidic conditions at temperatures ranging from 20° C. to 50° C. for 0.1 to 10 hours. The methylolation and etherification steps may be repeated to get the desired levels of methylolation and etherification. The resulting crosslinker is then isolated and filtered to achieve the final product.

Non-limiting examples of monoalkylamines that may be used in the reaction are monomethylamine, monoethylamine, mono-n-propylamine, monoisopropylamine, mono-n-butylamine, monoisobutylamine, monoethylhexylamine and phenylamine.

Non-limiting examples of alcohols that may be used in the etherification step are methanol, ethanol, n-propanol, isopropanol, n-butanol, isobutanol, cyclohexanol, phenol, benzyl alcohol, monoalkyl ether of ethylene or propylene glycol and mixtures thereof.

The methylolation step is preferably conducted in the presence of a catalyst. An acid or base catalyst may be used. Non-limiting examples of acid catalysts are: p-toluenesulfonic acid, sulfamic acid, glacial acetic acid, mono or polychlorinated acetic acids, sulfuric acid, nitric acid, napthylenesulfonic acid, alkyl phosphonic acids, phosphoric acid and formic acid. Non-limiting examples of base catalysts are inorganic basic salts such as the hydroxides, carbonates or bicarbonates of lithium, sodium, potassium, calcium and magnesium, or the organic bases and basic salts such as amines and guanidine, quaternary-ammonium, phosphonium hydroxide and (bi-)carbonate salts.

The etherification reaction is preferably conducted in a presence of an acid catalyst. The same acid catalysts described above for the methylolation reaction may also be used in the etherification reaction.

In the preparation of the compounds of Formula I, oligomeric products resulting from a self-condensation reaction may be obtained. Non-limiting examples of these self-condensation products are given in Formulas II and III below.

One embodiment is a crosslinking oligomer compound having the Formula II: 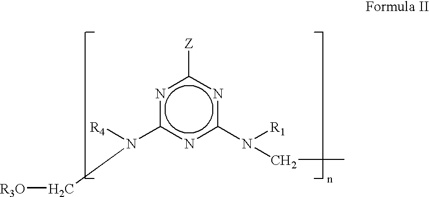
wherein n is 2 to 50; Z and R₁ to R₆ are defined above.

A further embodiment is a crosslinking oligomer compound having the Formula III: 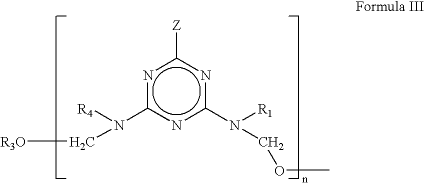
wherein n is 2 to 50; Z and R₁ to R₆ are defined above.

The curable composition of the present invention may comprise a mixture of crosslinking compounds. Preferred mixtures of crosslinking compounds contain at least two of mono-, bis- and tris-alkyl melamine formaldehyde crosslinking compounds. Preferred examples of mono-alkyl melamine formaldehyde crosslinking compounds in Formula I are when Z is —NR₅CH₂OR₆, R₁ and R₄ are hydrogen or —CH₂OR₆ and R₂, R₃, R₅ and R₆ are each independently a C₁ to C₄ alkyl. Preferred examples of bis-alkyl melamine formaldehyde crosslinking compounds in Formula I are when Z is —NR₅CH₂OR₆, R₁ is hydrogen or —CH₂OR₆ and R₂ to R₆ are each independently a C₁ to C₄ alkyl. Preferred examples of tris-alkyl melamine formaldehyde crosslinking compounds in Formula I are when Z is —NR₅CH₂OR₆, and R₁ to R₆ are each independently a C₁ to C₄ alkyl.

The crosslinking compounds of the present invention are combined with a carbamate resin to form the curable composition. One embodiment of a carbamate resin is a urethane resin, which is well-known in the art. Urethane resins are typically produced by reacting a polyisocyanate with a “reactive isocyanate-containing material,” such as a polyol, although other methods may be used in this invention to make urethane resins. The term “reactive isocyanate-containing material” means a material containing groups that are reactive with isocyanate functionalities.

Suitable polyisocyanates used for preparing the urethane resins include aliphatic, cycloaliphatic, araliphatic, and/or aromatic polyisocyanates, and mixtures thereof. Preferably, the polyisocyanate is aliphatic or cycloaliphatic polyisocyanate.

Examples of useful aliphatic and cycloaliphatic polyisocyanates include 4,4-methylenebisdicyclohexyl diisocyanate (hydrogenated MDI), hexamethylene diisocyanate (HDI), isophorone diisocyanate (IPDI), methylenebis(cyclohexyl isocyanate), trimethyl hexamethylene diisocyanate (TMDI), meta-tetramethylxylylene diisocyanate (TMXDI), and cyclohexylene diisocyanate (hydrogenated XDI). Other aliphatic polyisocyanates include isocyanurates of IPDI and HDI.

Examples of suitable aromatic polyisocyanates include tolylene diisocyanate (TDI) (i.e., 2,4-tolylene diisocyanate, 2,6-tolylene diisocyanate or a mixture thereof), diphenylmethane-4,4-diisocyanate (MDI), naphthalene-1,5-diisocyanate (NDI), 3,3-dimethyl-4,4-biphenylene diisocyanate (TODI), crude TDI (i.e., a mixture of TDI and an oligomer thereof), polymethylenepolyphenyl polyisocyanate, crude MDI (i.e., a mixture of MDI and an oligomer thereof), xylylene diisocyanate (XDI) and phenylene diisocyanate.

The components from which the urethane resin is formed comprise at least one “reactive isocyanate-containing material.” Non-limiting examples of suitable reactive isocyanate-containing materials comprise polyols, polyethers, polyesters, polycarbonates, polyamides, polyurethanes, polyureas, and mixtures thereof. Preferably, the reactive isocyanate-containing materials are polyols.

In one embodiment, the active reactive isocyanate-containing material may be one or more low molecular weight polyols such as those having two to four hydroxyl groups. The weight average molecular weight of the low molecular weight polyol is typically less than 3000, and is preferably less than 700, and may be between 60 and 250 grams per mole. Examples of suitable low molecular weight polyols include diols, triols, and tetraols having 1 to 10 carbon atoms such as ethylene glycol, 1,2-propylene glycol, 1,4-butanediol, trimethylolpropane, ditrimethylolpropane, trimethylolethane, glycerol, pentaerythritol, sorbitol and dihydroxyalkanoic acids such as dimethylol propionic acid. Examples of other low molecular weight polyols are ether polyols such as diethylene glycol and ethoxylated bisphenol A.

The low molecular weight polyols can be used in amounts of up to about 50 percent by weight, and preferably from about 2 to about 50 percent based on the total weight of the resin solids used to prepare the urethane resin.

Other suitable polyols include polycarbonate polyols, polyester polyols, polyether polyols, carboxyl containing polyols, hydroxyl-containing polydiene polymers, hydroxyl-containing acrylic polymers, and mixtures thereof.

Examples of polyester polyols and hydroxyl containing acrylic polymers are described in U.S. Pat. Nos. 3,962,522 and 4,034,017. These polymeric polyols generally can have a weight average molecular weight ranging from 400 to 10,000 grams per mole.

Generally, the amount of reactive isocyanate-containing material that is used to prepare the urethane resin is at least about 30 weight percent, preferably at least about 35 weight percent, and more preferably from about 35 to about 50 percent by weight based on total weight of the resin solids used to make the polyurethane material.

Another embodiment of a carbamate resin is a pendant carbamate resin containing pendant carbamate functionality. A representative non-limiting example of a pendant carbamate resin is shown in Figure IV below: 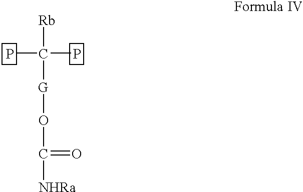
wherein P represents the polymer or resin chain, G is a direct bond or a divalent linking group and Rₐ and R_{b} are independently hydrogen or an organic residue. Preferably, G is a direct bond, an alkylene of 1 to 18 carbon atoms, an arylene of 6 to 18 carbon atoms or —C(O)—O—R_{c}— wherein R_{c} is an alkylene of 1 to 8 carbon atoms or an arylene of 6 to 18 carbon atoms; and Rₐ and R_{b} are independently hydrogen or C₁ to C₈ alkyl. More preferably, G is a direct bond, a C₁ to C₄ alkylene or —C(O)—O—R_{c}— where R_{c} is a C₁ to C₄ alkylene.

Pendant carbamate resins may be prepared by any suitable method. There are a number of different processes that may be used such as those disclosed in U.S. Pat. Nos. 5,356,669; 5,693,723; 6,075,168; 6,235,858; 6,331,596 and 6,462,144, the disclosures which are herein incorporated by reference. Another useful reference is “Esters of Carbamic Acid,” Phillip Adams and Frank A. Baron, Chemical Review, V.65, pgs. 557-602 (1965), herein incorporated by reference.

One way to prepare such pendant carbamate resins is to prepare an acrylic monomer having a carbamate functionality in the ester portion of the monomer. Such monomers are well-known in the art. One preparation method involves reacting a hydroxy ester with urea to form a carbamate acrylic monomer. Another method is to react an α,β-unsaturated acid ester with a hydroxy carbamate ester to form the carbamate monomer. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid or anhydride to form the carbamate functional acrylic monomer. Other methods of preparing carbamate-modified acrylic monomers are described in the art, and can be utilized as well. The acrylic monomer can then be polymerized along with other ethylenically-unsaturated monomers, if desired, by techniques such as solution polymerization in a non-aqueous solvent, aqueous emulsion or dispersion polymerization, all which are well-known in the art. Suitable organic solvents or mixture of organic solvents that are inert towards the monomers used for solution polymerization include aromatic hydrocarbons, such as xylene, toluene, higher boiling aliphatic or cylcoaliphatic hydrocarbons, for example various white spirits, mineral turpentine, etc. The resulting polymer is suitable for solvent borne coating composition. Aqueous emulsion polymerization can be carried out in presence of suitable anionic, cationic or non-ionic surfactants. The resulting polymer is suitable for waterborne coating compositions.

An alternative route for preparing the pendant carbamate resin is to react an already-formed hydroxy-functional containing polymer such as an hydroxy-functionalized acrylic or polyester polymer with another component to form the pendant carbamate functionality appended to the polymer backbone, as described in U.S. Pat. No. 4,758,632, the disclosure of which is incorporated herein by reference. One technique for preparing pendant carbamate resins involves thermally decomposing urea, which gives off ammonia and HNCO, in the presence of a hydroxy-functional polymer to form a carbamate-functional acrylic polymer.

Another technique involves reacting the hydroxyl group of a hydroxyalkyl carbamate with the isocyanate group of an isocyanate-functional acrylic or vinyl monomer to form the carbamate-functional acrylic. Isocyanate vinyl monomers are well-known in the art and include the unsaturated isopropenyl dimethyl benzene isocyanate (M-TMI® from Cytec Industries Inc). Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514. Yet another way to prepare the pendant carbamate is to trans-esterify a hydroxyl-containing polymer with an alkyl carbamate. The carbamate compound can be any compound having a carbamate group capable of undergoing a transesterification with the hydroxyl groups on the base resin. These include, without limitation, methyl carbamate, butyl carbamate, propyl carbamate, 2-ethylhexyl carbamate, cyclohexyl carbamate, phenyl carbamate, glycol ether carbamates, hydroxypropyl carbamate, hydroxyethyl carbamate, and the like. The transesterification reaction between the hydroxyl groups on the resin and the carbamate compound can be conducted under typical transesterification conditions, e.g., temperatures from room temperature to 150° C. with transesterification catalysts such as calcium octoate, aluminum isopropoxide, dibutyl tin laurate, dibutyl tin oxide, Bi(III) compound, Zr(IV) compound, mixtures of butyl stannoic acid and other esterification catalysts known in the art. The amount of esterification catalysts present is typically about 0.05 to about 10% by weight.

Suitable hydroxy-functional containing polymers that may be used in the above processes include, for example, polyfunctional hydroxy group containing materials such as polyols, hydroxy-functional acrylic resins having pendant hydroxy-functionalities, hydroxy-functional polyester resins having pendant hydroxy functionalities, hydroxy-functional polyethers resins having pendant hydroxy groups, polymers containing groups that impart water dispersibility such as carboxyl containing hydroxy-functional resins which may be neutralized by suitable amines, products derived from the condensation of epoxy compounds with an amine and mixtures thereof.

The carbamate resins of the present invention will generally have a number average molecular weight of 400 to 20,000, or 600 to 10,000, or 700 to 5000, or 800 to 3000. Molecular weight can be determined by the GPC method using a polystyrene standard.

The carbamate content of the carbamate resins, on an equivalent weight basis, will generally be between about 150 grams to about 5000 grams, or between about 200 grams to about 3000 grams or about 300 grams to about 1500 grams or about 300 grams to about 600 grams per equivalent carbamate functionality.

It is also possible that the carbamate resin may be formed “in situ” by combining individual components of the carbamate resin with the crosslinking compound of the present invention and heating the mixture. This “in situ” reaction is covered by the scope of the recited claims.

In addition to the crosslinking compounds and the carbamate resins, the curable composition of the present invention may also contain further optional components.

For example, the curable composition may contain other active hydrogen-containing resins, in addition to the carbamate resins. These resins contain functionalities reactive with the crosslinking compound such as hydroxy, carboxy, amino, amido, mercapto, or a blocked functionality which is convertible to any of the preceding reactive functionalities. These active hydrogen-containing materials are those which are conventionally used in amino resin coatings, and in general are considered well-known to those of ordinary skill in the relevant art.

Suitable active hydrogen-containing materials include, for example, polyfunctional hydroxy group containing materials such as polyols, hydroxy-functional acrylic resins having pendant or terminal hydroxy functionalities, hydroxy-functional polyester resins having pendant or terminal hydroxy functionalities, products derived from the condensation of epoxy compounds with an amine, and mixtures thereof. Acrylic and polyester resins are preferred. Examples of the polyfunctional hydroxy group containing materials include DURAMAC® 203-1385 alkyd resin (Eastman Chemical Co.); BECKSOL® 12-035 Coconut Oil Alkyd (Reichhold Chemical Co., Durham, N.C.); JONCRYL® 500 and 1540 acrylic resin (Johnson Polymers, Racine, Wis.); AT-400 acrylic resin (Rohm & Haas, Philadelphia, Pa.); CYPLEX® polyester resin (Cytec Industries, West Paterson, N.J.); CARGILL® 3000 and 5776 polyester resins (Cargill, Minneapolis, Minn.); TONE® polyester resin (Union Carbide, Danbury, Conn.); K-FLEX® XM-2302 and XM-2306 resins (King Industries, Norwalk, Conn.); CHEMPOL® 11-1369 resin (Cook Composites and Polymers (Port Washington, Wis.); CRYLCOAT® 3494 solid hydroxy terminated polyester resin (UCB CHEMICALS USA, Smyrna, Ga.); RUCOTE® 101 polyester resin (Ruco Polymer, Hicksville, N.Y.); JONCRYL® SCX-800-A and SCX-800-B hydroxy-functional solid acrylic resins (Johnson Polymers, Racine, Wis.); and the like.

Examples of carboxyfunctional resins include CRYLCOAT® solid carboxy terminated polyester resin (UCB CHEMICALS USA, Smyrna, Ga.). Suitable resins containing amino, amido, carbamato or mercapto groups, including groups convertible thereto, are in general well-known to those of ordinary skill in the art and may be prepared by known methods including copolymerizing a suitably functionalized monomer with a comonomer capable of copolymerizing therewith.

The amount of these optional active hydrogen-containing materials that may be added should be such that the carbamate content of the total active-hydrogen resins (i.e., carbamate resin plus other optional non-carbamate active hydrogen resins) on an equivalent weight basis should not be above about 5000 grams, or not above about 3000 grams or not above about 1500 grams per equivalent carbamate functionality.

The curable compositions of the present invention may optionally further comprise a cure catalyst. The cure catalysts usable in the present invention include sulfonic acids, aryl, alkyl, and aralkyl sulfonic acids; aryl, alkyl, and aralkyl phosphoric and phosphonic acids; aryl, alkyl, and aralkyl acid pyrophosphates; carboxylic acids; sulfonimides; mineral acids and mixtures thereof. Of the above acids, sulfonic acids are preferred when a catalyst is utilized. Examples of the sulfonic acids include benzenesulfonic acid, para-toluenesulfonic acid, dodecylbenzenesulfonic acid, dinonylnaphthalenedisulfonic acid and a mixture thereof. Examples of the aryl, alkyl, and aralkyl phosphates and pyrophosphates include phenyl, para-tolyl, methyl ethyl, benzyl, diphenyl, di-para-tolyl, di-methyl, di-ethyl, di-benzyl, phenyl-para-tolyl, methyl-ethyl, phenyl-benzyl phosphates and pyrophosphates. Examples of the carboxylic acids include benzoic acid, formic acid, acetic acid, propionic acid, butyric acid, dicarboxylic acids such as oxalic acid, fluorinated acids such as trifluoroacetic acid, and the like. Examples of the sulfonimides include dibenzene sulfonimide, di-para-toluene sulfonimide, methyl-para-toluene sulfonimide, dimethyl sulfonimide, and the like. Examples of the mineral acids include nitric acid, sulfuric acid, phosphoric acid, poly-phosphoric acid, and the like. All of the above acid catalysts may be blocked with an amine. Non-limiting examples of such amines are dimethyl oxazolidine, 2-amino-2-methyl-1-propanol, n,n-dimethylethanolamine or combinations thereof.

The curable composition may also contain other optional ingredients such as fillers, light stabilizers, pigments, flow control agents, plasticizers, mold release agents, corrosion inhibitors, and the like. It may also contain, as an optional ingredient, a medium such as a liquid medium to aid the uniform application and transport of the curable composition. Any or all of the ingredients of the curable composition may be contacted with the liquid medium. Particularly preferred is a liquid medium, which is a solvent for the curable composition ingredients. Suitable solvents include aromatic hydrocarbons, aliphatic hydrocarbons, halogenated hydrocarbons, ketones, esters, ethers, amides, alcohols, water, compounds having a plurality of functional groups such as those having an ether and an ester group, and mixtures thereof.

Preferably, the weight ratio of the carbamate resin plus any optional active hydrogen-containing material to the crosslinking compound (dry weight basis) is in the range of from about 99:1 to about 0.5:1 or about 10:1 to about 0.8:1 or about 4:1 to about 0.8:1.

The weight percent of the cure catalyst, if present, is in the range of from about 0.01 to about 5.0 wt. % based on the weight of the crosslinker and carbamate resin plus optional active hydrogen-containing resins (dry weight basis).

The present coating compositions may employ a liquid medium such as a solvent, or it may employ solid ingredients as in powder coatings, which typically contain no liquids. Contacting may be carried out by dipping, spraying, padding, brushing, rollercoating, flowcoating, curtaincoating, electrocoating or electrostatic spraying.

The liquid or powder coating compositions and a substrate to be coated are contacted by applying the curable composition onto the substrate by a suitable method, for example, by spraying in the case of the liquid compositions and by electrostatic spraying in the case of the powder compositions. In the case of powder coatings, the substrate covered with the powder composition is heated to at least the fusion temperature of the curable composition forcing it to melt and flow out and form a uniform coating on the substrate. It is thereafter fully cured by further application of heat, typically at a temperature in the range of about 120° C. to about 220° C. for a period of time in the in the range of about 5 minutes to about 30 minutes and preferably for a period of time in the range of 10 to 20 minutes.

In the case of the liquid compositions, the solvent is allowed to partially evaporate to produce a uniform coating on the substrate. Thereafter, the coated substrate is allowed to cure at temperatures of about 20° C. to about 150° C., or about 25° C. to about 120° C. for a period of time in the range of about 20 seconds to about 30 days depending on the temperature used to obtain a cured film. In a particularly advantageous embodiment curable compositions of the present invention can be heat cured at lower temperatures preferably ranging from about 20° C. to about 120° C. or about 70° C. to about 110° C.

Another embodiment of this invention is a waterborne curable composition comprising the crosslinking compound of Formula I, water and a carbamate resin (in the form of an aqueous emulsion, water reducible polymer or polyurethane dispersion, etc.).

The waterborne curable composition may permit formation of a dispersion, emulsion, invert emulsion, or solution of the ingredients of the curable composition. The waterborne curable composition may optionally contain a surfactant, an emulsification agent, a dispersant or mixtures thereof.

The amount of total solids present in the waterborne curable composition is about 1 to about 50 wt. %, or about 5 to about 40 wt. % or about 10 to about 30 wt. %, based on the total weight of the composition.

The weight ratio of carbamate resin plus optional active hydrogen-containing material to crosslinker of Formula I (dry weight basis) present in the waterborne curable composition is about 99:1 to about 1:1 or 95:5 to about 60:40 or about 90:10 to about 70:30.

The amount of surfactant present in the waterborne curable composition is about 0 to about 10 wt. %, or about 0.1 to about 5 wt. % or about 0.5 to about 2 wt. %, based on the weight of the carbamate resin plus optional active hydrogen-containing material (dry weight basis) in the composition.

The solvent components in the waterborne curable composition are solvents such as water and optional co-solvents. Examples of such optional co-solvents are the solvents listed above. Preferred examples of co-solvents for waterborne curable compositions are alcohols and glycol ethers. The amount of co-solvent that may be used is from 0 to about 30 wt. % or about 2 to about 25 wt. % or about 5 to about 15 wt. %, based on the total weight of the carbamate resin plus optional active hydrogen-containing material and crosslinker of Formula I (dry weight basis) in the waterborne curable composition.

Surfactants, emulsification agents and/or dispersants are molecules, which have a hydrophobic portion (A) and a hydrophilic portion (B). They may have the structure A-B, A-B-A, B-A-B, etc. Typically, the hydrophobic section can be an alkyl, an alkaryl, a polypropylene oxide block, a polydimethylsiloxane block or a fluorocarbon. The hydrophilic block of a non-ionic surfactant is a water soluble block, typically a polyethylene oxide block or a hydroxylated polymer block. The hydrophilic block of an anionic surfactant is typically an acid group ionized with a base. Typical acid groups are carboxylic acids, sulfonic acids or phosphoric acids. Typical bases used to ionize the acids are NaOH, KOH, NH₄OH and a variety of tertiary amines, such as triethyl amine, triisopropyl amine, dimethyl ethanol amine, methyl diethanol amine and the like.

The anionic surfactants that may be used include, for example, a fatty acid salt, a higher alcohol sulfuric acid ester, an alkylbenzene sulfonate, an alkyl naphthalene sulfonate, a naphthalene sulfonic acid-formarin condensation product, a dialkyl sulfone succinate, an alkyl phosphate, a polyoxyethylenesulfate and an anion composed of a special polymer active agent. Particularly preferred are, for example, a fatty acid salt such as potassium oleate and a higher alcohol sulfuric acid ester salt such as sodium lauryl sulfate. The cationic surfactants include, for example, an alkylamine salt, a quaternary ammonium salt and a polyoxyethylene alkylamine. Particularly preferred is a quaternary ammonium salt such as lauryl trimethyl ammonium chloride or cetyltrimethyl ammonium chloride. Amphoteric surfactants include alkylbetaines such as laurylbetaine and stearylbetaine. The non-ionic surfactants include, for example, a polyoxyethylenealkyl ether, a polyoxyethylene alkylphenol ether, a sorbitane fatty acid ester, a polyoxyethylene sorbitane fatty acid ester, a polyoxyethylene acryl ester, an oxyethylene-oxypropylene block polymer and a fatty acid monoglyceride.

The curable compositions of this invention may be employed as coatings in the general areas of coatings such as original equipment manufacturing (OEM) including automotive coatings, general industrial coatings including industrial maintenance coatings, architectural coatings, agricultural and construction equipment coatings (ACE), powder coatings, coil coatings, can coatings, wood coatings, and low temperature cure automotive refinish coatings. They are usable as coatings for wire, appliances, automotive parts, furniture, pipes, machinery, and the like. Suitable surfaces include metals such as steel and aluminum, plastics, wood, and glass.

The curable compositions of the present invention are particularly well suited to coat heat sensitive substrates such as plastics and wood which may be altered or destroyed entirely at the elevated cure temperatures prevalent in the heat curable compositions of the prior art.

The present invention will now be illustrated by the following examples. The examples are not intended to limit the scope of the present invention. In conjunction with the general and detailed descriptions above, the examples provide further understanding of the present invention.

### EXAMPLES

### Example 1

### Preparation of N-alkylmelamine Formaldehyde Crosslinking Agent Trismethoxymethyl Trimethylmelamine (TMMTMM)

A suitable reactor equipped with nitrogen sparge, mechanical agitation, temperature control, water condenser and vacuum distillation set up was used for this preparation. Thus, 2.5 mole of N,N′,N″-trimethyl melamine was methylolated with methyl formcel, 4.5 mole equivalent of formaldehyde, under alkaline conditions (pH 10.0 to 11.0) at 45° C. for 25 minutes, followed by alkylation with 10.0 mole equivalent methanol under acidic conditions (pH 2.5 to 3.0, temperature 35 to 40° C.) and stripped, under reduced pressure, following neutralization to pH 10 to 11. A second methylolation with 1.5 mole equivalent formaldehyde and alkylation with 10.0 mole equivalent methanol (pH 2.0 to 2.5, 35° C., 25 minutes) was carried out followed by neutralization to basic pH and stripping, under reduced pressure for product concentration. The resulting product obtained upon filtration was 600 grams of clear crosslinking agent at 98 to 100% foil solids and Gardner Holt viscosity in range of V to Y.

### Example 2

### Pendant Carbamate Resin Preparation

A primary carbamate functional acrylic resin was prepared from the following ingredients:

TABLE 1
Primary Carbamate resin ingredients

| Ingredients | Weight in grams |
|---|---|
| Methyl carbamate | 117.5 |
| Joncryl ®504 | 443.0 |
| Catalyst-aluminum isoproxide | 5.2 |

A suitable reactor equipped with nitrogen sparge and a Dean-Stark trap was charged with methyl carbamate and hydroxyl functional acrylic resin Joncry®504 (from Johnson Polymers), heated to 110 to 120° C. and held at temperature for one hour to remove traces of moisture. The reactor contents were cooled to below 100° C. prior to catalyst addition. A reflux temperature of 130 to 140° C. was maintained for 45 hours as methanol was trapped off. The progress of this transcarbamoylation reaction was monitored by hydroxyl number and FT-IR, to at least 92 to 96% conversion. A clear primary carbamate functional resin (400 grams) at 75% solids was obtained by filtration with a carbamate content of approximately 430 grams/equivalent.

A secondary carbamate functional acrylic resin was prepared from the following ingredients:

TABLE 1A
Secondary Carbamate resin ingredients

| Ingredients | Weight in grams |
|---|---|
| Xylene | 57.0 |
| Joncryl ®580 | 170.0 |
| Octyl isocyanate | 75.0 |

A suitable reactor equipped with a nitrogen sparge was charged with xylene, heated to 110 to 125° C. and held at temperature for one hour to remove traces of moisture. The reactor contents were cooled to below 100° C. prior to addition of the solid hydroxyl functional acrylic resin Joncryl®580. Octyl isocyanate was added to the viscous resin solution and allowed to react at 75 to 85° C. for 5 to 7 hours. The progress of this carbamate formation reaction was monitored by disappearance of the isocyanate peak using FT-IR, to at least 99-100% conversion. A clear secondary carbamate functional resin (300 grams) at 75% solids was obtained.

### Example 3

### Preparation of Coating Compositions

The coating compositions were prepared by mixing the following ingredients.

TABLE 2
Ingredients for Coating Composition

| | |
|---|---|
| Carbamate Resin of Example 2 (75% solids) | 93.8 g |
| TMMTMM resin of Example 1 | 30.0 g |
| Cycat 600 Catalyst | 1.43 g |
| AMP-95 (2-amino-2-methyl-1-propanol) | 0.35 g |
| Methanol | 8.22 g |
| Xylene | 10.0 g |
| Propylene Glycol Monomethyl Ether Acetate | 9.5 g |
| Dynoadd F-100 Flow Control Additive | 0.5 g |
| Total | 153.8 g |

### Examples 3C-1 and 3C-2

### Preparation of Comparative Coating Compositions

Comparative coating compositions were prepared similarly to Example 3 above. One comparative coating composition contained a hexamethoxymethyl melamine (HMMM) crosslinking agent with the carbamate resin of Example 2 at about a 1:3 ratio on total resin solids (3C-1) and the other contained the TMMTMM crosslinking agent of Example 1 with an acrylic hydroxyfunctional resin (Joncryl® 500 from Johnson Polymers) at about a 1:3 ratio on total resin acids (3C-2).

### Example 4

### Preparation of Films

Films were prepared by applying a few grams of the coating composition of Examples 3 and to the top of a 4″×12″ primed steel panel and using a wire-wound cator to drawdown the applied formulation resulting in a uniform film. The coated panel is then allowed to flash at room temperature for about 10 minutes and then placed in an oven for 30 minutes at the desired cure temperatures.

### Example 5

### Film Properties

Film hardness (KHN₂₅), MEK solvent resistance and Film Thickness were determined for each of the films prepared at various cure temperatures in Example 4 above.

TABLE 3
Film Hardness (KHN₂₅)

| | Example 3 | Example 3C-1 | Example 3C-2 |
|---|---|---|---|
| | TMMTMM with | (HMMM with | TMMTMM with |
| Cure Temp ° C. | carbamate | carbamate) | Joncryl ® 500 |
| 90 | 12.4 | | 7.0 |
| 100 | 13.5 | 0.8 | 9.4 |
| 110 | 14.4 | 9.3 | 14.3 |
| 120 | | 11.7 | |
| 130 | | 12.4 | |

TABLE 4
MEK Solvent Resistance

| | Example 3 | Example 3C-1 | Example 3C-2 |
|---|---|---|---|
| | TMMTMM with | (HMMM with | TMMTMM with |
| Cure Temp ° C. | carbamate | carbamate) | Joncryl ® 500 |
| 90 | 50/200 | | 125/200 |
| 100 | 200+ | 10/75 | 200+ |
| 110 | 200+ | 125/200 | 200+ |
| 120 | | 200+ | |
| 130 | | 200+ | |

Solvent Resistance is measured by methyl ethyl ketone (MEK) double rubs to mar (first number) and remove (2^{nd} number) the coatings. Highly crosslinked coatings require 200+ (i.e., more than 200) rubs to mar.

TABLE 5
Dry Film Thickness, mils (Avg./Std. Dev.)

| | Example 3 | Example 3C-1 | Example 3C-2 |
|---|---|---|---|
| | TMMTMM with | (HMMM with | TMMTMM with |
| Cure Temp ° C. | carbamate | carbamate) | Joncryl ® 500 |
| 90 | 1.78/0.09 | | 1.96/0.10 |
| 100 | 1.74/0.07 | 1.65/0.10 | 1.85/0.10 |
| 110 | 1.72/0.12 | 1.73/0.09 | 1.83/0.10 |
| 120 | | 1.81/0.12 | |
| 130 | | 1.78/0.10 | |

The results show that the curable composition of the present invention cured at lower temperature (100° C.) with better hardness and MEK solvent resistance than the Comparative Examples.

### Example 6

### Cleveland Humidity Resistance

Cleveland Humidity resistance testing as performed by ASTM D 4585 (Testing Water Resistance of Coatings Using Controlled Condensation) was measured for films prepared with compositions in Examples 3 and 3C-2 at 38° C. and 60° C. temperatures. These results are shown below in Tables 6 to 11 at various cure temperatures.

TABLE 6
Cleveland Humidity at 38(C using 90(C cure temperature
(20 (Gloss/Blister rating)

| | Example 3 | Example 3C-2 |
|---|---|---|
| Time (hrs) | TMMTMM with carbamate | TMMTMM with Joncryl ® 500 |
| 0 | 97.8/10 | 98.0/10 |
| 240 | 95/10 | 8M |
| 336 | | 97.3/8M |
| 528 | 97.3/10 | 96.2/8M |
| 750 | 10 | |
| 1000 | 97.2/10 | |
| 1224 | | 96.7/8MD |

Blister Rating - ASTM D 714 Standard Test Method for Evaluating
Degree of Blistering of Paints
Gloss - ASTM D 523 Standard Test Method for Specular Gloss

Legend for Blister Rating (Size & Frequency)

| | Description |
|---|---|
| Size | |
| 10 | No blisters |
| 9 | Microblisters |
| 8 | Small blisters |
| 6 | Medium Blisters |
| Frequency | |
| D | Dense |
| MD | Medium Dense |
| M | Medium |
| F | Few |

TABLE 7
Cleveland Humidity at 38° C. using 100° C. cure
temperature (20° Gloss/Blister rating)

| | Example 3 | Example 3C-2 |
|---|---|---|
| | TMMTMM with | TMMTMM with |
| Time (hrs) | carbamate | Joncryl ® 500 |
| 0 | 98.4/10 | 97.4/10 |
| 240 | 98.7/10 | 8M |
| 336 | | 97.8/8MD |
| 528 | 98.43/10 | 98.3/8MD |
| 750 | 10 | |
| 1000 | 98.0/10 | |
| 1224 | | 98.9/8M |

TABLE 8
Cleveland Humidity at 38° C. using 110° C. cure
temperature (20° Gloss/Blister rating)

| | Example 3 | Example 3C-2 |
|---|---|---|
| | TMMTMM with | TMMTMM with |
| Time (hrs) | carbamate | Joncryl ® 500 |
| 0 | 98.9/10 | 98.1/10 |
| 240 | 99.6/10 | 8F |
| 336 | | 97.2/8F |
| 528 | 99.1/10 | 98.9/8M |
| 750 | 10 | |
| 1000 | 98.9/10 | |
| 1224 | | 100.0/8M |

TABLE 9
Cleveland Humidity at 60° C. using 90° C. cure
temperature (20° Gloss/Blister rating)

| | Example 3 | Example 3C-2 |
|---|---|---|
| | TMMTMM with | TMMTMM with |
| Time (hrs) | carbamate | Joncryl ® 500 |
| 0 | 97.7/10 | 95.4/10 |
| 16 | 9D | 8M |
| 40 | 9D | 8M |
| 240 | 95.0/9D | 8M |
| 336 | | 1.3/6D‡ |
| 500 | 97.1/9D | |

‡Film Hazy from Moisture pickup

TABLE 10
Cleveland Humidity at 60° C. using 100° C. cure
temperature (20° Gloss/Blister rating)

| | Example 3 | Example 3C-2 |
|---|---|---|
| | TMMTMM with | TMMTMM with |
| Time (hrs) | carbamate | Joncryl ® 500 |
| 0 | 98.3/10 | 98.6/10 |
| 16 | 10 | 8MD |
| 40 | 10 | 8MD |
| 240 | 98.2/10 | 8MD‡ |
| 336 | | 0.6/8D‡ |
| 500 | 98.4/10‡ | |

‡Film hazy from moisture pickup.

TABLE 11
Cleveland Humidity at 60° C. using 110° C. cure
temperature (20° Gloss/Blister rating)

| | Example 3 | Example 3C-2 |
|---|---|---|
| | TMMTMM with | TMMTMM with |
| Time (hrs) | carbamate | Joncryl ® 500 |
| 0 | 98.9/10 | 99.3/10 |
| 16 | 10 | 8M |
| 40 | 10 | 8M |
| 240 | 98.7/10 | 8M‡ |
| 336 | | 60.2/8D‡ |
| 500 | 98.7/10 | |

‡Film Hazy from Moisture pickup

The results show that the curable composition of the present invention has superior Cleveland Humidity Resistance than the Comparative Example.

### Example 7

### Preparation of Waterborne Curable Composition

The following procedure was used to prepare a waterborne curable composition using N-alkylmelamine formaldehyde crosslinking agent and a carbamate resin.

A primary carbamate functional acrylic monomer was prepared from the following ingredients.

TABLE 12
Ingredients for carbamate functional acrylic monomer

| Ingredients | Weight in grams |
|---|---|
| Hydroxyethyl carbamate | 86.0 |
| Methacrylic anhydride | 129.9 |
| Inhibitor | 0.0 |
| Water | 200 to 400 |
| 25% Sodium hydroxide | 0.0 to 68 |

A suitable reactor was charged with the ingredients and heated to 100° C. The reaction mixture was held at this temperature until the methacrylic anhydride was completely reacted with the hydroxyethyl carbamate, as determined by Infra Red spectroscopy. The reaction product is cooled to ambient temperature. Removal of methacrylic acid from the product was achieved by washing with either de-ionized water alone or de-ionized water and caustic, followed by phase separation. The bottom layer containing the clear colorless product (75-90% yield) was collected and used for the preparation of the carbamate functional acrylic latex discussed below.

A carbamate functional latex was prepared by the emulsion polymerization, of methyl methacrylate, butyl acrylate and the carbamate functional monomer discussed above by using the following ingredients and procedure:

TABLE 13
Carbamate functional latex ingredients

| | Parts by Weight | |
|---|---|---|
| A. Kettle Charge | | |
| DI Water | 130 | |
| Aerosol ® 501 (50%) | 3.0 | |
| Butyl acrylate (BA) | 10.5 | |
| Methyl methacrylate (MMA) | 13.1 | |
| Initial Catalyst | | |
| DI water | 15.0 | |
| Potassium Persulfate | 0.4 | |
| B. Monomer Charge | | |
| DI Water | 50.0 | |
| Aerosol ® 501 (50%) | 10.0 | |
| Aerosol ® 103 (34%) | 4.0 | |
| Butyl acrylate (BA) | 105.0 | |
| Methyl methacrylate (MMA) | 110.0 | |
| Carbamate function monomer (88.9% solution) | 54.6 | |
| Initiator Feed | | |
| Potassium persulfate | 0.4 | |
| DI Water | 30.0 | |
| Emulsion Vessel Rinse | 5.0 | parts DI water |

A suitable jacketed reactor with mechanical agitation, temperature control, monomer and initiator feed lines; condenser was heated to 65° C. with nitrogen purge. The aqueous surfactant solution was charged to the reactor and temperature allowed to equilibrate. The nitrogen purge was slowed down, the kettle monomer charge was added and time allowed for temperature to re-equilibrate. The kettle initiator was charged added to the reactor; following which exotherm was noted. The monomer feed was started over a 2.5 to 3 hour total feed time. Once monomer feed was complete the reaction temperature was increased to 75° C. and was held for another 60 minutes. At this point the reactor was cooled to 45° C. and the emulsion polymer was filtered through previously weighed 100 mesh paint filter paper. A stable emulsion at pH 4.9, percent solids at 50.4%, viscosity of 24.4 cps (measured at 20 rpm, spindle #1) and a calculated Tg of 20° C. was obtained.

A clear film-forming water-borne composition was prepared by mixing together the following ingredients:

TABLE 14
Ingredients for waterborne curable composition

| | Solid Weight | Solution weight |
|---|---|---|
| Ingredient | in grams | in grams |
| Carbamate-functional acrylic latex of | 85.0 | 170.0 |
| Table 13 | | |
| Deionized Water | | 42.6 |
| Dimethylethanolamine | | 1.0 |
| Cycat ® 600 Catalyst | 1.0 | 1.43 |
| 2-amino-2-methyl-1-propanol (95% in | | 0.35 |
| water) | | |
| Methanol | | 8.22 |
| Byk ® 348 Flow Control Agent | 0.3 | 0.3 |
| TMMTMM resin of example 1 | 15.0 | 15.0 |
| Dipropylene glycol monomethy ether | | 15.0 |

Byk ® is a registered trademark of BYK-Chemie.

Films were prepared by applying a few grams of the waterbone coating composition to the top of a 4″×12″ glass panel and using a bird applicator to drawdown the applied formulation resulting in a uniform film. The coated panel was then allowed to flash at room temperature for about 10 minutes and was then placed in an oven for 30 minutes at the desired cure temperatures.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A curable composition comprising:
(i) a crosslinking compound having the structure of Formula I: 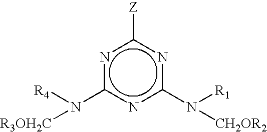
wherein Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms; and
(ii) a carbamate resin.

2. The curable composition of claim 1, wherein Z is —NR₅CH₂OR₆ and R₁ to R₆ are each independently a C₁ to C₈ alkyl.

3. The curable composition of claim 2, wherein R₁ to R₆ are each independently a C₁ to C₄ alkyl.

4. The curable composition of claim 1, wherein the carbamate resin is a urethane resin.

5. The curable composition of claim 4, wherein said urethane resin will have a carbamate content of about 200 grams to about 3000 grams per equivalent carbamate functionality.

6. The curable composition of claim 1, wherein the carbamate resin is a pendant carbamate resin.

7. The curable composition of claim 6, wherein said pendant carbamate resin has a pendant carbamate group of the formula —O—CO—NHR₇, wherein R₇ is hydrogen or a C₁ to C₈ alkyl.

8. The curable composition of claim 7, wherein said pendant carbamate resin will have a carbamate content of about 150 to about 5000 grams per equivalent carbamate functionality.

9. The curable composition of claim 1 further comprising a cure catalyst.

10. The curable composition of claim 9, wherein said cure catalyst is blocked by an amine.

11. The curable composition of claim 1 further comprising a solvent.

12. The curable composition of claim 1, wherein said crosslinking compound is a mixture of at least two compounds selected from the group consisting of mono-, bis- and tris-alkyl melamine formaldehyde crosslinking compounds.

13. A waterborne curable composition comprising:
(ii) a crosslinking compound having the structure of Formula I: 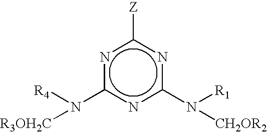
wherein Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms;
(ii) a carbamate resin; and
(iii) water

14. The waterborne curable composition of claim 13, wherein Z is —NR₅CH₂OR₆ and R₁ to R₆ are each independently a C₁ to C₈ alkyl.

15. The waterborne curable composition of claim 14, wherein R₁ to R₆ are each independently a C₁ to C₄ alkyl.

16. The waterborne curable composition of claim 13, wherein the carbamate resin is a urethane resin having urethane linkages of the formula —NH—CO—O— in the backbone of the carbamate resin.

17. The waterborne curable composition of claim 16, wherein said urethane resin will have a carbamate content of about 200 to about 3000 grams per equivalent carbamate functionality.

18. The waterborne curable composition of claim 13, wherein the carbamate resin is a pendant carbamate resin having a pendant carbamate group.

19. The waterborne curable composition of claim 18, wherein said pendant carbamate group has the formula —O—CO—NHR₇, wherein R₇ is hydrogen or a C₁ to C₈ alkyl.

20. The waterborne curable composition of claim 18, wherein said pendant carbamate resin will have a carbamate content of about 150 to about 5000 grams per equivalent carbamate functionality.

21. The waterborne curable composition of claim 13 further comprising a cure catalyst.

22. The waterborne curable composition of claim 13 further comprising a surfactant, an emulsification agent, and/or a dispersant.

23. The curable composition of claim 13, wherein said crosslinking compound is a mixture of at least two compounds selected from the group consisting of mono-, bis- and tris-alkyl melamine formaldehyde crosslinking compounds.

24. A curable composition comprising: 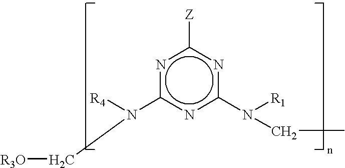
wherein n is 2 to 50;
Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms;
(ii) a carbamate resin; and
(iii) optionally water

25. A curable composition comprising: 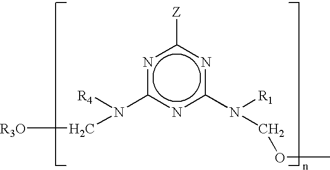
wherein n is 2 to 50;
Z is a hydrogen, an alkyl of 1 to about 18 carbon atoms, an aryl of about 6 to about 24 carbon atoms, an aralkyl of about 7 to about 24 carbon atoms or —NR₅CH₂OR₆;
R₁, R₄ and R₅ are each independently hydrogen, —CH₂OR₆, an alkyl of 1 to about 18 carbon atoms, an aryl of about 6 to about 24 carbon atoms or aralkyl of about 7 to about 24 carbon atoms, with the proviso that at least one R₁, R₄ and R₅ is an alkyl, aryl or aralkyl; R₂, R₃ and R₆ are each independently hydrogen, alkyl, aryl, aralkyl, alkoxyalkyl or an alkaryl having from 1 to about 24 carbon atoms;
(ii) a carbamate resin; and
(iii) optionally water.
